(19) United States
(12) Patent Application Publication
(10) Pub. No.: US 2012/0278115 A1
(43) Pub. Date: Nov. 1, 2012

(54) Method and Apparatus for Leveraging Social Media for Pro-Active Customer Notification

(75) Inventors: Arup Acharya, Nanuet, NY (US); Gary J. Wright, White Plains, NY (US); Schachi Sharma, Delhi (IN); Nilanjan Banerjee, Kolkata West Bengal (IN)

(73) Assignee: INTERNATIONAL BUSINESS MACHINES CORPORATION, Armonk, NY (US)

(21) Appl. No.: 13/094,922

(22) Filed: Apr. 27, 2011

(51) Int. Cl. G06Q 10/00

(52) U.S. Cl. 705/7.13

(57) ABSTRACT

Customers are contacted on social media websites and instant messaging programs by monitoring a plurality of network-enabled user-interactive sites, e.g., social media websites, for an active presence of a customer on one of the sites. Upon detection of an active presence, a customer support agent is assigned to the customer associated, and a communication channel of customer's choice is established between the agent and the customer. This communication channel is used to exchange messages between the assigned agent and the associated predefined customer. A single contact center representation is established on each site, and a separate logical representation of each single contact center representation is established on premises equipment associated with the agent. The logical representation on the agent premises equipment is used to establish the communication channel between the customer support agent and the associated predefined customer.

### FIELD OF THE INVENTION

The present invention relates to computer-based customer service.

### BACKGROUND OF THE INVENTION

Businesses often have a need to contact customers. In addition to contacting potential customers to promote a product or service, these businesses contact existing customers to make them aware of changes to services or products that they have, to alert them to recalls, to alert them regarding potential security breaches of online information and to remind them regarding the current billing status of their account. Typically, such contacts are made using the both paper mailings and E-mail. In addition, many businesses utilize agent-staffed outbound call centers to contact customers over the telephone.

These outbound contact centers have traditionally operated by having agents call up customers. However, many customers having more than one associated telephone number, and customers, especially younger customers, are trending away from the use of telephones in favor or texting or other instant messaging applications and social media networks such as Facebook and Twitter. Therefore, the outbound contact centers need an approach to contact customers using instant messaging applications and social media networks.

### SUMMARY OF THE INVENTION

Systems and methods in accordance with exemplary embodiments of the present invention interact with customers, and in particular a group of existing or predefined customers, through a social media network of the customer's choosing when that customer is available on a given social media network. Therefore, customer presence on these social media sites is leveraged, and customer desire for interaction through their medium of choice is satisfied. When the presence of a customer on a given social media site is detected, the most appropriate agent is identified, and an appropriate media channel is established between this agent and the customer. The agent is selected based on the identification of both the customer being contacted and the social media site on which the presence of that customer was detected. Thus, the agent will have the desired familiarity with the customer and with the operating and interaction modalities of the social media site. In addition, the established communication channel is configured appropriately for the particular social media site on which the customer is present.

### BRIEF DESCRIPTION OF THE DRAWINGS

FIG. 1 is a schematic representation of an embodiment of a system for leveraging social media for pro-active customer notification in accordance with the present invention;

FIG. 2 is a schematic representation of an embodiment of a single contact center server creating single contact center representations on multiple sites and logical representations for a group of agents; and

FIG. 3 is a flow chart illustration an embodiment of a method for leveraging social media for pro-active customer notification in accordance with the present invention.

### DETAILED DESCRIPTION

The present invention utilizes four main components in order to leverage existing network-based and network-enabled user-interactive sites including instant messaging sites and social media sites. These sites provide for simultaneous multi-user participation and are provided as network based applications running across both local area networks and wide area network such as the Internet or World Wide Web. A given user can participate in one or more social media sites and can customize each site according to their preferences. In addition, users are not continuously logged onto a given site and or nor always actively participating in or interacting with a given site. In order to interact with a given user, including a predefined customer to be contacted, through a given network-enabled user-interactive site, that customer needs to be present in that site. As used herein, presence of a customer on a given site refers to the online status of a given customer on a given network-enabled user-interactive site. Presence has been described as a publish-subscribe system for context. Therefore, presence can be used to determine both the physical location of a customer and the virtual location of that customer on a given network-enabled user-interactive site. A given customer's presence can extend across multiple domains and multiple network-enabled user-interactive sites.

Therefore, the first component or module utilized by the present invention determines or detects the presence of one or more customers from a predefined group of customers on one or more network-enabled user-interactive site. This module delivers an abstract view of when a given customer is online or is available on a given site. Each customer may connect to a plurality of network-enabled user-interactive sites across a plurality of networks. These sites include, but are not limited to Facebook, Twitter and Skype. In one embodiment, presence of a given customer on a given network-enabled user-interactive site is accomplished using site-specific application programming interfaces (APIs) to detect when a customer is available on that site. These APIs are associated with or provided with the computer software applications that provide the functionality to the sites. Therefore, the APIs are used to probe the sites for information or data that evidences the presence of a given customer on that site.

If a given network-enabled user-interactive site does not have a direct API available to detect user presence, alternate means are used to detect customer presence. In one embodiment, the actual site representations themselves are monitored for evidence of customer presence on those sites. For example, by detecting or seeing that a customer has posted a message, a comment, a photo, a video or a tweet on a given site, systems and methods in accordance with the present invention deduce that the customer is online and actively present on that site. As any given customer can participate in multiple sites, this module simultaneously monitors for presence on all identified network-enabled user-interactive sites. This monitoring can be aggregated for each customer. Therefore, this module aggregates presence detection across multiple network-enabled user-interactive sites to create a virtual view of when a given customer is online. Once presence of a given customer from the predefined list of customers is detected, this module notifies the next module of the present invention, the virtual agent, regarding detection of the customer's online presence.

The virtual agent module virtualizes the pool or group of available customer support agents. Systems and methods in accordance with the present invention utilize a group of agents that contains a plurality of customer service or customer support agents. These agents may be located in a single physical location or may be dispersed across a plurality of distinct locations. Although each agent in the group of agents may be equally capable to handle any type of customer contact across any type of network-enabled user-interactive site, typically agents vary in terms of their level of experience, areas of expertise and knowledge of the interface modalities of each network-enabled user-interactive site. The virtual agent looks at all of the available agents as a group, and the most appropriate available agent from that group upon detection of a given customer is selected to interact with that customer.

The present invention provides for the identification and selection of an appropriate agent from the group of agents in the virtual agent module based on a plurality of rules or criteria for agent selection. In addition to the traditional rules for agent selection including prior interaction history with a given customer, expertise with particular subject matter or physical location of the agent relative to the physical location of the customer that are used to select an agent to interact with the customer, additional criteria are used including familiarity of agents with specific characteristics of the customer's choice of network-enabled user-interactive site. Having identified the most appropriate agent from the group of agents, a communication channel is established between the agent the customer. The established communication channel is appropriately formatted in accordance with the network-enabled user-interactive site through which the agent and customer will communicate.

The next module is the interaction channel module. This module accounts for the various network-enabled user-interactive sites on which customer presence may be detected. Each agent is provided with a logical interaction channel through which to interact with a customer. Therefore, each agent does not interact with customers on a given network-enabled user-interactive site using a separate account specifically for that agent on that same network-enabled user-interactive site. Rather, the agents interface with the network-enabled user-interactive sites through a single logical interaction channel. This single interaction channel is used regardless of the network-enabled user-interactive site on which a given customer is present. For example, a given customer may be logged onto the network-enabled user-interactive site Facebook. Rather than each agent in the group of agents also being logged onto each network-enabled user-interactive site being monitored in order to be available for a communication session with that customer, each agent is in communication with the various network-enabled user-interactive sites through the single logical interaction channel.

A single contact center representation is provided on each of the network-enabled user-interactive sites. Then, a logical representation is instantiated across multiple physical agents on the agent equipment associated with each agent. When a customer comes online on Facebook, and a first agent is selected to interface with that customer, a logical channel is established between the first agent and the customer. Messages to the first agent are trapped by the single common customer contact center representation on Facebook and then are routed through the single logical interaction channel to the first customer. Conversely, messages to from the first agent are routed through the single logical interaction channel to the single common contact center representation on the network-enabled user-interactive site for display to the customer. Thus, the single contact center representation on each social network acts as a multiplexer/de-multiplexer between physical customer service agents and customers on that network-enabled user-interactive site. Once such a suitable communication channel is established, the first agent interacts with customer via that channel. To the extent possible, specific characteristics of a social media can be abstracted away using this notion of a logical channel. However, some social media interactions may be vastly different. In those cases, a channel is established that is closely tied to the specific interaction modality of a given social network. For example, on Twitter, messages or Tweets are restricted to 140 bytes; therefore, an agent selected to communicate with a customer via Twitter would need to be cognizant of this restriction.

The fourth module utilized by the present invention is a media gateway. In one embodiment, messages received on the single logical channel from agents are routed to and posted on the appropriate specific network-enabled user-interactive sites according to the respective APIs associated with those network-enabled user-interactive sites. Similarly, messages posted by users on the single contact center representation of a given network-enabled user-interactive site are imported from that network-enabled user-interactive site, for example Facebook, using site-specific APIs and are then placed on the single logical interaction channel for delivery to the appropriate customer service agent. Therefore, the single contact center representation works in conjunction with the single logical channel to provide a media gateway between agents and customers.

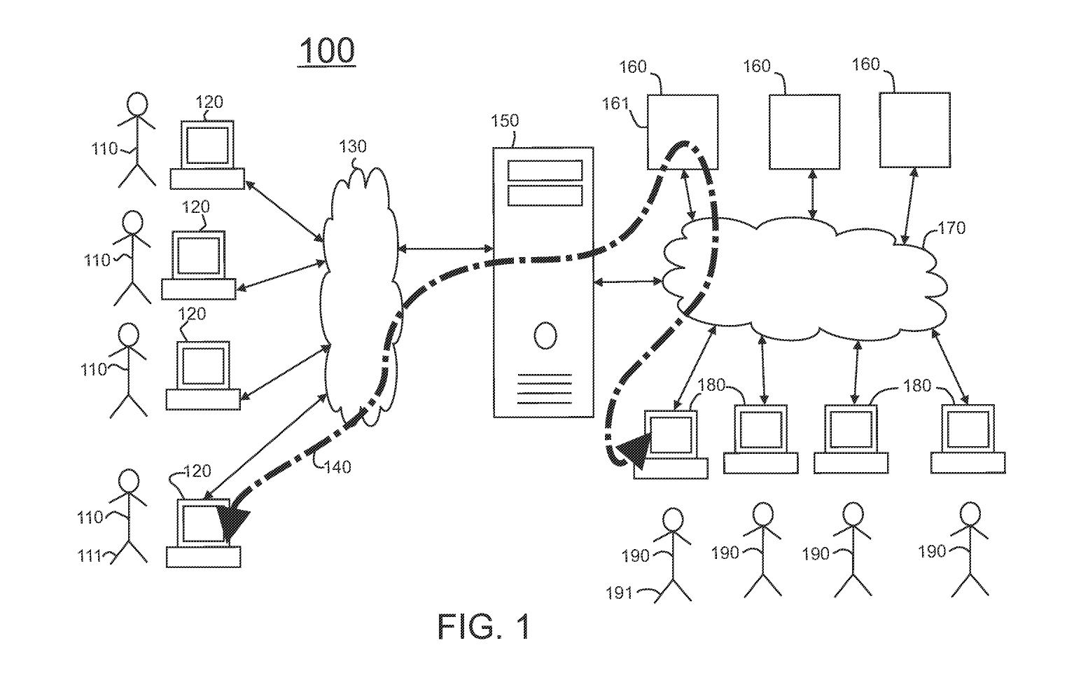

Referring initially to FIG. 1, an exemplary embodiment of a system for providing customer notifications by leveraging instant messaging and social media sites 100 is illustrated. The system includes a group of a plurality of agents 110, and each agent is provided with agent premises equipment 120 to interact with customers. The groups of agents can be located in a single physical location or can be distributed across a plurality of distinct physical locations. In addition, each agent can be substantially identical in terms of expertise and functionality. Alternatively, each agent has a unique set of characteristics and competencies that define a profile for that agent. These profiles include the physical location of the agent, a log of the agent's previous customer contacts, a list of the customer's contacted by that agent, technical areas of expertise of the agent, competencies with various network-enabled user-interactive sites and an identification of the agent premises equipment. The agent profiles can be stored in one or more databases that are accessible by the system. Suitable agent premises equipment provide for interaction between the agents and customers through the network-enabled user-interactive sites and include network-enabled computing devices such as personal computers, mainframe computing systems, servers, personal digital assistants, smart phones and any other web enabled device.

Each agent 110 and in particular the agent premises equipment 120 associated with each agent, is in communication with a single contact server 150 across one or more local or wide area networks 130. The single contact server is in communication with all of the agents 110 and with the plurality of network-enabled user-interactive sites 160. Therefore, the single contact server provides the single contact center representation that appears on each network-enabled user-interactive site. In addition, the single contact server is the interface between he single contact center representations on the network-enabled user-interactive sites and the separate logical representations that appear on the agent premises equipment 120 associated with each agent 110. The single contact server functions as a single logical server to perform all of the functions of the present invention including creation of the group of agents, selecting appropriate agents, maintaining agent profiles and establishing and maintaining communication channels between agents and customers 190. Although functioning as a single logical server, the single contact server 150 can include a plurality of local or distributed servers and other suitable computing systems and computing system components.

The system also includes a plurality of network-enabled user-interactive sites 160. These sites include, but are not limited to, social networking sites and instant messaging applications that allow users to interact with each other to exchange text, photos and videos. Examples of these network-enabled user-interactive sites include Facebook and Twitter among other similar sites. A plurality of predefined customers 190 are included in the users of these network-enabled user-interactive sites and use customer premises equipment 180 to interact with the sites 160 across one or more local or wide area networks 170. Suitable customer premises equipment includes personal computers, personal digital assistants, smart phones or any other network enabled communication and interface device. Each customer 190 has an account or page on one or more of the network-enabled user-interactive sites. These accounts provide a customizable graphical user interface for each customer on each site. Customers control access to their accounts by other users. In addition, the sites can provide general information or other information of interest to each account, for example, notifications important events or birthdays, friend suggestions, and promotional materials.

As with the customers, the single contact center server 150 is in communication with all of the network-enabled user-interactive sites across one or more local or wide area networks 170. The single contact center server 150 has a single contact center representation on each on of the sites. These representations can vary from site to site, can be exactly the same from site to site or can contain both common and site specific elements to aid the customers in identifying the single contact center representations. In one embodiment, these single contact center representations are provided in the accounts of the customers at the request or direction of the single contact center server. Alternatively, the customers request placement of the single contact center representations within their accounts, for example by acknowledging that they are a customer of the business represented by the single contact center representation. In addition, the customers can accept the single contact center representation into their group of followers or friends and can receive posts, pokes or messages from the single contact center representation. The customer can agree to follow the tweets of the single contact center representation or can add the single contact center representation to an instant messaging, texting or group chat session. In general, however, each customer appears to be reacting with the same single contact center representation and not with one of a plurality of different customer support agents. All agents interact with the customers of a given network-enabled user-interactive site using the same single contact center representation, and the single contact center server is responsible for directing communication traffic through this single contact center representation to the appropriate customers and agents. These components facilitate the creation of communication channel 140 between an identified agent 111 and a predefined customer 191 whose presence was detected on one of the sites 161. The communication channel runs from the customer premises equipment 180 associated with the customer 191 whose presence was detected through the site 161 on which that presence was detected and in particular through the single content center representation on that site, through the single contact center server 150 and then to the agent premises equipment 120 associated with the selected agent 111.

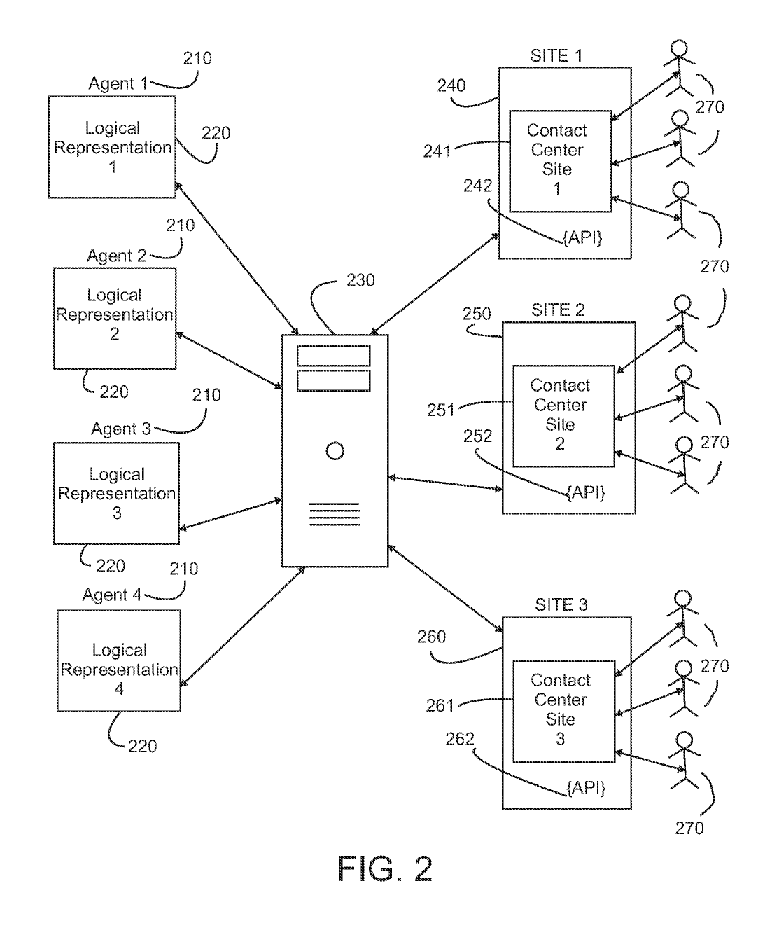

Referring to FIG. 2, an embodiment illustrating the interaction of agents and customers across network-enabled user-interactive sites 200 utilizing the system of the present invention is provided. The plurality of agents 210 each has a single distinct logical representation 220 of the contact center representations on all of the network-enabled user-interactive sites. These logical representations 220 provide the necessary information for the agents to interact with the customers including an identification of the customer, the customer's profile, the customer's history and the network-enabled user-interactive site on which the presence of the customer was detected. Preferably, these logical representations are unique to each agent and a generic across all sites. The logical representations are provided on the agent premises equipment associated with each agent by the single contact center server 230 that is in contact with the plurality of sites including a first site 240, a second site 250 and a third site 260. The single contact center server provides a single contact center representation 241 on the first site 240, another single contact center representation 251 on the second site 250 and a third single contact center representation 261 on the third site 260. The single contact center server also monitors each site for a presence of one of a plurality of customers 270 on one of the sites. The single contact server combines presence monitoring on all sites into an aggregated view of presence monitoring. In addition, the single contact server combines all of the single contact center representations into a single aggregated logical representation that is provided to the agents as their respective logical representations.

The customers 270 interact with the same single contact center representation on each given site. Through these interactions, the single contact center server 230 establishes communication channels for the exchange of messages and data between the agents 210 and the customers. In one embodiment, monitoring sites for customer presence and maintaining communication channels is facilitated by the use of a first set of APIs 242 on the first site, a second set of APIs 252 on the second site and a third set of APIs 262 on the third site. These APIs are associated with and provided in computer software applications that provide the desired functionality to their associated sites.

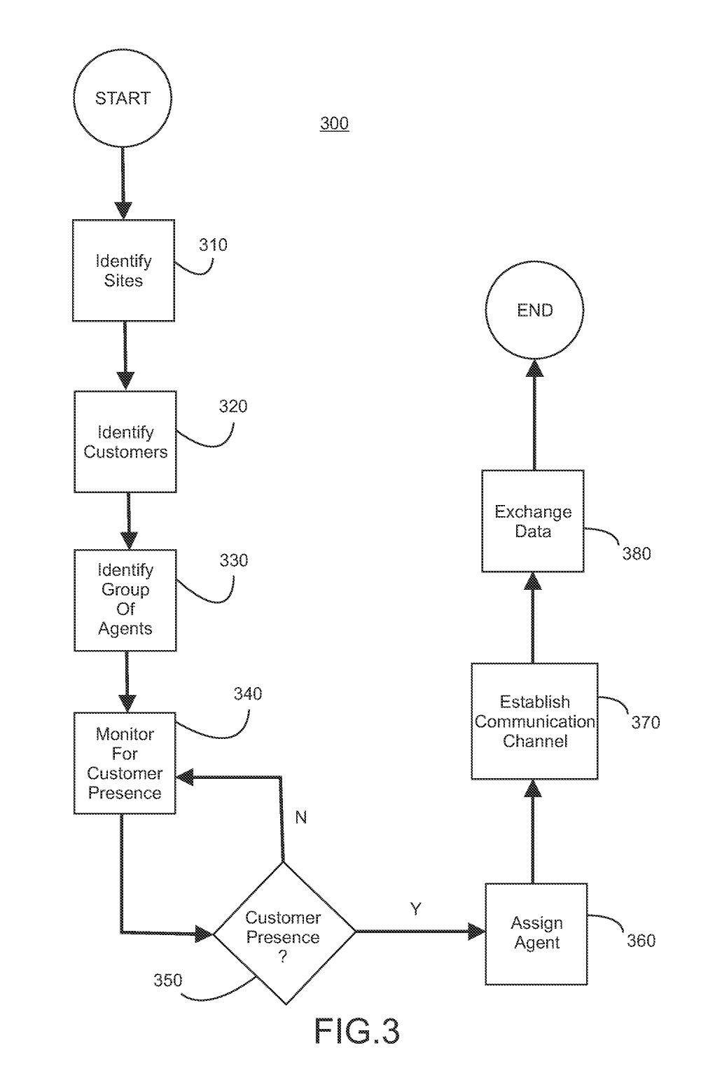

Referring to FIG. 3, an exemplary embodiment of a method for contacting customers 300 using embodiments of the system for leveraging network-enabled user-interactive sites for pro-active customer notification in accordance with the present invention is illustrated. A plurality of separate and distinct network-based and network-enabled user-interactive sites is identified 310. Suitable network-enabled user-interactive sites include social networking sites or instant messaging sites as described above. The network functionality of the sites allows a plurality of users to interact simultaneously using the functionality of the sites. Potential users of the site include customers that a business or other entity needs to provide information. Therefore, from the potential users of the network-enabled user-interactive sites, a plurality of predefined customers is identified 320. Each customer is a physical customer using customer premises equipment at that customer's location to interact with the network-enabled user-interactive sites and with the communication channels of the present invention.

Agents are used to provide the desired information to the predefined customers. Therefore, a group containing a plurality of customer support agents available to participate in exchanging messages with customers across the communication channels of the present invention is created 330. Each agent is a physical agent using agent computer equipment at the agent's location to interact with one or more communication channels.

Having identified the sites, customers and agents, all of the identified sites are monitored simultaneously for an active presence of one of a plurality of predefined customers on one of the plurality of network-enabled user-interactive sites 340. In one embodiment, monitoring of the network-enabled user-interactive sites involves using APIs from computer software applications associated with each network-enabled user-interactive site to monitor for evidence of the active presence of one of the predefined customers on each network-enabled user-interactive site. Each computer software application from which an API is derived provides network-enabled user-interactive functionality to its associated site. In addition to using APIs, a user interface, e.g., a website, for each network-enabled user-interactive site is directly monitored for evidence of an active presence of one of the plurality of predefined customers on that network-enabled user-interactive site. For example, the site is monitored for messages or other posts to the site that evidence that a given customer is actively using that site, i.e., is present on that site. Receipt of a tweet or instant message can also be used to provide evidence of customer presence on a given site. Since multiple sites are being monitored at the same time, the simultaneous monitoring of the plurality of network-enabled user-interactive sites is aggregated to produce an overall network-based presence view across all monitored network-enabled user-interactive sites for each one of the plurality of predefined customers.

If no active presence of one of the predefined customers is detected on one of the monitored sites 350, then site monitoring continues. When the active presence of one of the predefined customers on one of the network-enabled user-interactive sites is detected, the identity of the customer and the site on which the customer's presence was detected is noted. Then, one of the plurality of customer support agents from the group of customer support agents is assigned to the predefined customer associated with the detected active presence 360. In one embodiment, one of the plurality of customer support agents is assigned by selecting one of the plurality of customer support agents from the group of customer support agents based on at least one of a prior interaction history between the selected customer support agent and the associated predefined customer, technical expertise of the selected customer support agent, physical location of the selected customer support agent in relation to a physical location of the associated predefined customer and familiarity of the selected customer support agent with specific characteristics of the network-enabled user-interactive site on which presence of the associated predefined customer is detected.

Having assigned a customer service agent to the detected active presence of one of the predefined customers, a communication channel is established between the assigned agent and the associated predefined customer 370. In one embodiment, a communication channel is established that is compatible with the specific interaction modality associated with the network-enabled user-interactive site on which presence of the associated predefined customer is detected. In addition, the communication channel is formatted for compatibility with the network-enabled user-interactive site on which presence of the associated predefined customer is detected.

The established communication channel is used to exchange messages between the assigned agent and the associated predefined customer 380. In one embodiment, the APIs for the computer software applications associated with the network-enabled user-interactive site on which customer presence was detected are used to post messages from the communication channel to the network-enabled user-interactive site and to place messages posted on the network-enabled user-interactive site to the communication channel. Again, each computer software program from which an API is derived provides network-enabled user-interactive functionality to their respective sites.

In one embodiment, a single contact center representation is established on each network-enabled user-interactive site. In addition, a separate logical representation of each single contact center representation is established on agent premises equipment associated with each customer support agent. Therefore, all customers view and interact with a single contact center representation on each network-enabled user-interactive site, and each customer support agent interacts with its own logical representation of the single contact center representations from all of the network-enabled user-interactive sites. In order to establish the communication channel, the logical representation on the agent premises equipment associated with the assigned customer support agent of the single contact center representation from the network-enabled user-interactive site on which presence of the customer is detected is used to establish the communication channel between the customer support agent and the associated predefined customer. In one embodiment, the single contact center server that is in communication with agent premises equipment associated with each customer support agent and with each network-enabled user-interactive site is used to establish each single contact center representation. In addition, using the communication channel to exchange messages includes using the single contact center representation on the network-enabled user-interactive site to receive messages from the associated predefined customer and to route those messages to the assigned customer support agent through the communication channel.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In one embodiment, the present invention is directed to a machine-readable or computer-readable storage medium containing a machine-executable or computer-executable code that when read by a machine or computer causes the machine or computer to perform a method for contacting customers in accordance with exemplary embodiments of the present invention and to the computer-executable code itself. The machine-readable or computer-readable code can be any type of code or language capable of being read and executed by the machine or computer and can be expressed in any suitable language or syntax known and available in the art including machine languages, assembler languages, higher level languages, object oriented languages and scripting languages. The computer-executable code can be stored on any suitable storage medium or database, including databases disposed within, in communication with and accessible by computer networks utilized by systems in accordance with the present invention and can be executed on any suitable hardware platform as are known and available in the art including the control systems used to control the presentations of the present invention.

While it is apparent that the illustrative embodiments of the invention disclosed herein fulfill the objectives of the present invention, it is appreciated that numerous modifications and other embodiments may be devised by those skilled in the art. Additionally, feature(s) and/or element(s) from any embodiment may be used singly or in combination with other embodiment(s) and steps or elements from methods in accordance with the present invention can be executed or performed in any suitable order. Therefore, it will be understood that the appended claims are intended to cover all such modifications and embodiments, which would come within the spirit and scope of the present invention.

1. A method for contacting customers, the method comprising:
monitoring each one of a plurality of separate and distinct network-enabled user-interactive sites simultaneously using a computing system in communication with the sites, the sites monitored for an active presence of one of a plurality of predefined existing customers of a business on one of the plurality of network-enabled user-interactive sites;
detecting the active presence of one of the predefined customers on one of the network-enabled user-interactive sites;
assigning one of a plurality of customer support agents working for the business to the predefined customer associated with the detected active presence;
establishing a communication channel between the assigned agent and the associated predefined customer; and
using the communication channel to exchange messages between the assigned agent and the associated predefined customer.

2. The method of claim 1, wherein the step of monitoring the network-enabled user-interactive sites further comprises using application programming interfaces from computer software applications associated with each network-enabled user-interactive site to monitor for evidence of the active presence of one of the predefined customers on each network-enabled user-interactive site, each computer software application providing network-enabled user-interactive functionality to its associated site.

3. The method of claim 1, wherein the step of monitoring the network-enabled sites further comprises monitoring a user interface for each network-enabled user-interactive site for evidence of an active presence of one of the plurality of predefined customers on that network-enabled user-interactive site.

4. The method of claim 1, wherein the method further comprises aggregating the simultaneous monitoring of the plurality of network-enabled user-interactive sites to produce an overall network-based presence view across all monitored network-enabled user-interactive sites for each one of the plurality of predefined customers.

5. The method of claim 1, wherein the network-enabled user-interactive sites comprise social networking sites or instant messaging sites.

6. The method of claim 1, wherein:
the method further comprises creating a group comprising the plurality of customer support agents available to participate in exchanging messages with customers across the communication channel; and
the step of assigning one of the plurality of customer support agents further comprises selecting one of the plurality of customer support agents from the group of customer support agents based on at least one of a prior interaction history between the selected customer support agent and the associated predefined customer, technical expertise of the selected customer support agent, physical location of the selected customer support agent in relation to a physical location of the associated predefined customer and familiarity of the selected customer support agent with specific characteristics of the network-enabled user-interactive site on which presence of the associated predefined customer is detected.

7. The method of claim 1, wherein the step of establishing the communication channel further comprises formatting the communication channel for compatibility with the network-enabled user-interactive site on which presence of the associated predefined customer is detected.

8. The method of claim 1, wherein each agent comprises a physical agent using agent computer equipment to interact with the communication channel and each customer comprises a physical customer using customer premises equipment to interact with the network-enabled user-interactive sites and the communication channel.

9. The method of claim 1, wherein:
the method further comprises:
establishing a single contact center representation on each network-enabled user-interactive site; and
establishing a separate logical representation of each single contact center representation on agent premises equipment associated with each customer support agent; and
the step of establishing the communication channel further comprises using the logical representation on the agent premises equipment associated with the assigned customer support agent of the single contact center representation from the network-enabled user-interactive site on which presence of the customer is detected to establish the communication channel between the customer support agent and the associated predefined customer.

10. The method of claim 9, wherein the step of establishing the single contact center representation further comprises using a single contact center server in communication with agent premises equipment associated with each customer support agent and with each network-enabled user-interactive site to establish each single contact center representation.

11. The method of claim 9, wherein the step of using the communication channel to exchange messages further comprises using the single contact center representation to receive messages from the associated predefined customer and to route those messages to the assigned customer support agent.

12. The method of claim 1, wherein the step of establishing the communication channel further comprises establishing a communication channel that is compatible with a specific interaction modality associated with the network-enabled user-interactive site on which presence of the associated predefined customer is detected.

13. The method of claim 1, wherein the step of using the communication channel to exchange messages further comprises using application programming interfaces for computer software applications associated with the network-enabled user-interactive site on which customer presence was detected to post messages from the communication channel to the network-enabled user-interactive site and to place messages posted on the network-enabled user-interactive site to the communication channel, each computer software program providing network-enabled user-interactive functionality.

14. A method for contacting customers, the method comprising:
creating a group comprising a plurality of customer support agents working for a business and available to participate in exchanging messages with a plurality of predefined existing customers of the business across a communication channel through one of a plurality of network-enabled user-interactive sites;
detecting an active presence of one of the plurality of the predefined customers on one of the plurality of network-enabled user-interactive sites, using a computing system in communication with the sites;
selecting one of the plurality of customer support agents from the group of customer support agents based on at least one of a prior interaction history between the selected customer support agent and the detected predefined customer, technical expertise of the selected customer support agent, physical location of the selected customer support agent in relation to a physical location of the detected predefined customer and familiarity of the selected customer support agent with specific characteristics of the network-enabled user-interactive site on which presence of the predefined customer is detected;
assigning the selected customer support agent to the predefined customer associated with the detected active presence;
establishing a communication channel between the assigned customer support agent and the associated predefined customer; and
using the communication channel to exchange messages between the assigned customer support agent and the associated predefined customer.

15. The method of claim 14, wherein:
the method further comprises:
establishing a single contact center representation on each network-enabled user-interactive site; and
establishing a separate logical representation of each single contact center representation on agent premises equipment associated with each customer support agent; and
the step of establishing the communication channel further comprises using the logical representation on the agent premises equipment associated with the assigned customer support agent of the single contact center representation from the network-enabled user-interactive site on which presence of the customer is detected to establish the communication channel between the customer support agent and the associated predefined customer.

16. The method of claim 15, wherein the step of establishing the single contact center representation further comprises using a single contact center server in communication with agent premises equipment associated with each customer support agent in the group of customer support agents and with each network-enabled user-interactive site to establish the single contact center representation.

17. The method of claim 15, wherein the step of using the communication channel to exchange messages further comprises using the single contact center representation to receive messages from the associated predefined customer and to route those messages to the assigned selected customer support agent.

18. The method of claim 14, wherein the step of using the communication channel to exchange messages further comprises using application programming interfaces for computer software applications associated with the network-enabled user-interactive site on which customer presence was detected to post messages from the communication channel to the network-enabled user-interactive site and to place messages posted on the network-enabled user-interactive site to the communication channel, each computer software program providing network-enabled user-interactive functionality.

19. A method for contacting customers, the method comprising:
detecting an active presence of one of a plurality of predefined existing customers of a business on one of a plurality of network-enabled user-interactive sites, using a computing system in communication with the sites;
establishing a single contact center representation on each network-enabled user-interactive site;
establishing a separate logical representation of each single contact center representation on agent premises equipment associated with each customer support agent in a group of customer support agents comprising a plurality of customer support agents working for the business;
assigning one of the customer support agents to the predefined customer associated with the detected active presence;
establishing a communication channel between the assigned customer support agent and the associated predefined customer using the logical representation on the agent premises equipment associated with the assigned customer support agent of the single contact center of the network-enabled user-interactive site on which presence of the customer is detected to establish the communication channel between the assigned selected customer support agent and the associated predefined customer; and
using the communication channel to exchange messages between the assigned agent and the associated predefined customer.

20. The method of claim 19, wherein the step of establishing the single contact center representation further comprises using a single contact center server in communication with agent premises equipment associated with each customer support agent in the group of customer support agents and with each network-enabled user-interactive site to establish each single contact center representation.

21. The method of claim 19, wherein the step of using the communication channel to exchange messages further comprises using the single contact center representation to receive messages from the associated predefined customer and to route those messages to the assigned selected customer support agent.

22. The method of claim 19, wherein the step of using the communication channel to exchange messages further comprises using application programming interfaces for computer software applications associated with the network-enabled user-interactive site on which customer presence was detected to post messages from the communication channel to the network-enabled user-interactive site and to place messages posted on the network-enabled user-interactive site to the communication channel, each computer software program providing network-enabled user-interactive functionality.

23. The method of claim 19, wherein the network-enabled user-interactive sites comprise social networking sites or instant messaging sites.

24. A computer-readable storage medium containing a computer-readable code that when read by a computer causes the computer to perform a method for contacting customers, the method comprising:
monitoring each one of a plurality of separate and distinct network-enabled user-interactive sites simultaneously for an active presence of one of a plurality of predefined existing customers of a business on one of the plurality of network-enabled user-interactive sites;
detecting the active presence of one of the predefined customers on one of the network-enabled user-interactive sites;
assigning one of a plurality of customer support agents working for the business to the predefined customer associated with the detected active presence;
establishing a communication channel between the assigned agent and the associated predefined customer; and
using the communication channel to exchange messages between the assigned agent and the associated predefined customer.

25. The computer readable storage medium of claim 24, wherein:
the method further comprises:
establishing a single contact center representation on each network-enabled user-interactive site; and
establishing a separate logical representation of each single contact center representation on agent premises equipment associated with each customer support agent; and
the step of establishing the communication channel further comprises using the logical representation on the agent premises equipment associated with the assigned customer support agent of the single contact center representation from the network-enabled user-interactive site on which presence of the customer is detected to establish the communication channel between the customer support agent and the associated predefined customer.
